(19) United States
(12) Patent Application Publication
(10) Pub. No.: US 2021/0072115 A1
(43) Pub. Date: Mar. 11, 2021

(54) Roller Bearing Testing Device and Method

(71) Applicant: Mark McKinney, Chattanooga, TN (US)

(72) Inventor: Mark McKinney, Chattanooga, TN (US)

(21) Appl. No.: 17/012,545

(22) Filed: Sep. 4, 2020

Related U.S. Application Data
(60) Provisional application No. 62/896,664, filed on Sep. 6, 2019.

(51) Int. Cl. G01M 13/04; G01L 5/00

(52) U.S. Cl. CPC G01M 13/04; G01L 5/0019

(57) ABSTRACT

A test device for testing a tested article selected from the group of a loaded shaft and/or loaded bearings has a stationary crossbar with a load applicator movable relative thereto. The load applicator can be a threaded shaft which, when twisted, can selectively apply a load to the tested article. A sensor, such as a strain gage, can sense the applied load which is directed to a pulley and belt which connects to the tested article. As the tested article is rotated, the load can be applied and sensed and preferably displayed.

### CLAIM OF PRIORITY

This application claims the benefit of US Provisional application No. 62/896,664 filed September 6, 2019, which is incorporated by reference in its entirety, herein.

### FIELD OF THE INVENTION

The present invention relates to a roller bearing testing platform and method, and more particularly to a testing device and method of operation which applies a load to roller bearings during operations of a rotating shaft, such as driven by a motor, generator or other device.

### BACKGROUND OF THE INVENTION

A number of companies provide roller bearings in the marketplace. Many of these roller bearings are utilized when rebuilding motors and generators and the like.

However, to date, there is no test platform known by the applicant to test a bearing after being installed on a shaft, a generator or motor to be able to test that specific installed roller bearings perform properly under a specified load in a safe and effective manner.

The applicant is unaware of a testing device utilized to test bearings after being installed and ready for operation, such as within a motor (or rebuilt motor or generator, etc., to test specific roller bearing(s) under operational and/or test conditions under load.

Accordingly, a need exists for an improved testing device and method for load testing roller bearings installed on shafts, preferably without compromising satisfactory performing roller bearings.

### SUMMARY OF THE INVENTION

Accordingly, it is an object of many embodiments of the present invention to provide an improved roller bearing load test device and method.

It is an object of many embodiments of the present invention to provide an improved method and device for testing roller bearings installed on shafts, and more particularly roller bearings installed on motor or generator shafts.

It is another object of many embodiments of the present invention to provide an improved load testing device and method.

Accordingly, in accordance with a presently preferred embodiment of the present invention, a roller bearing load testing device is provided which can incrementally or otherwise apply load through a load applicator to a shaft and its respective bearings through the application of a belt with one end of the belt connected to (i.e. looped about) the loaded shaft and another end connected to (i.e. looped about) the test device (such as about a pulley). The pulley may be located on a test shaft which may be connected through a strain gauge or other load sensor to the load applicator. The load applicator may be a threaded rod received through a nut whereby relative rotation of the nut relative to the threaded rod moves the threaded rod to provide tension through the strain gauge or other load sensor through the testing device through the belt to a loaded shaft (with tested bearing(s) installed).

Depending on the particular embodiment selected, different widths and diameters of pulleys and/or belts could be utilized. A two-groove belt and pulley has been found to be particularly attractive for many embodiments. Knowing the specifications to be utilized for the test of the roller bearings, a user can apply a desired load to the shaft and its associated bearings utilizing the test device for a desired amount of load and/or run time.

For many embodiments, the device can connect to a loaded shaft utilizing a T-plate by providing a load applicator, such as a threaded rod with a nut resting on top of a crossbar of the T-plate. Then a user may selectively apply a load to the loaded shaft (and thus the bearings) as described herein. Specifically, the nut could be rotated thereby moving the threaded rod and thus a tension applied through a strain gauge to a test shaft having a pulley thereabout. A belt about the pulley connects to the loaded shaft to be tested with the installed bearing(s) under load. The loaded shaft may already be rotating or may now be rotated under load.

The test shaft may be connected on either end to pillow block bearings bolted or otherwise connected to respective base plates. Opposing pillow block bearings and base plates can be connected by opposing arms to a shoulder wherein the shoulder spans the arms and could connect to the strain gauge and threaded rod or other load applicator. Meanwhile the shoulder can also be connected to legs which could provide stability relative to posts of the T-bar. The legs could restrain movement of the shoulder to be vertical (or perpendicular) to the test shaft and/or shoulder.

In operation, a user can apply the desired amount of load by twisting the nut on the threaded rod (or rod relative to the nut, etc.). Output from the strain gauge could be provided to a shop scale readout or other display which could display the data provided by the strain gauge or other gauge or sensor so as to display the loading applied through the belt about the test shaft to the loaded shaft and its tested bearings. The loaded shaft could be rotated under a predetermined or other load(s) for more predetermined time(s). A controller or processor could also be employed to automate portion(s) of the process.

### BRIEF DESCRIPTION OF THE DRAWINGS

The particular features and advantages of the invention as well as other objects will become apparent from the following description taken in connection with the accompanying drawings in which:

FIG. 1 is a front perspective view of a testing device of the presently preferred embodiment of the present invention;

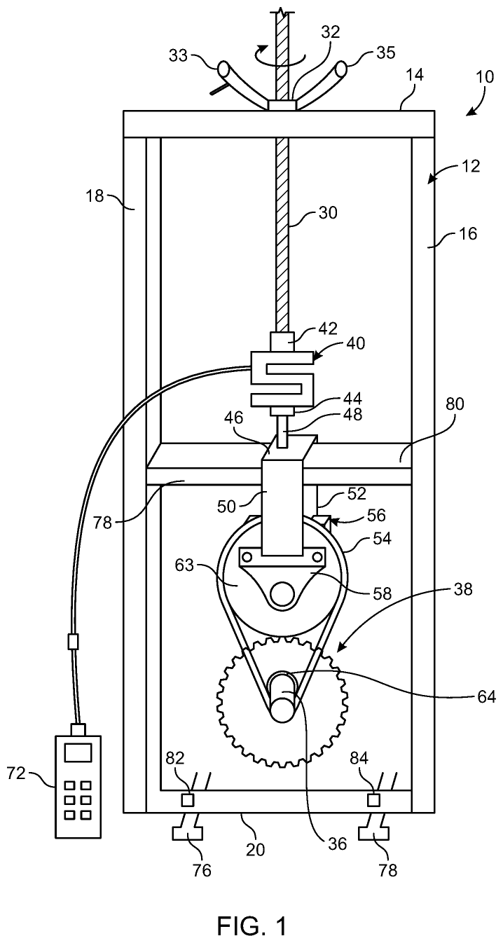

FIG. 2 is a side plan view of the invention of FIG. 1.

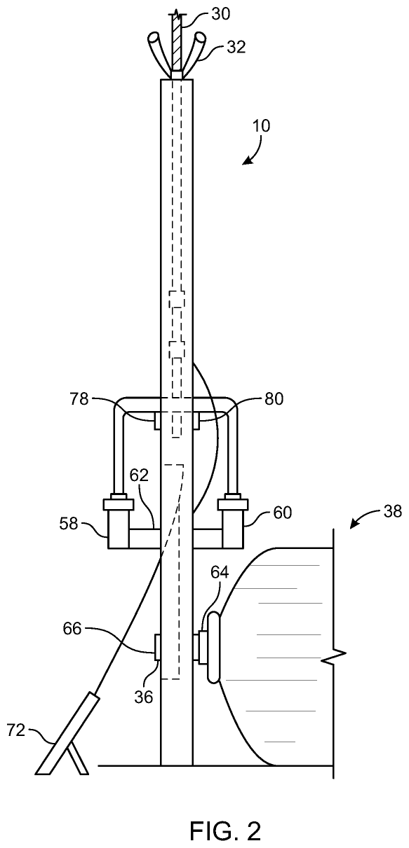

### DETAILED DESCRIPTION OF THE PREFERRED EMBODIMENT

A roller bearing loading device or test device 10 is illustrated in the Figures. The test device 10 may provide a T-plate 12 with a crossbar 14. A T-plate 12 often has opposing posts 16,18 supporting an upper crossbar 14. A lower base 20 may be secured such as with bolts 22,24 to tracks 26,28 in test facilities as would be understood by those of ordinary skill in the art or otherwise. Other support structures other than a T-plate may be utilized with other embodiments.

A load applicator (automated, or manual with wings 33,35 or other structure) may be provided such as with a threaded rod 30 directed through a nut 32 (or cooperating threads) which, depending on the direction of the twist of the rod 30 relative to nut 32, may apply or release a load to a belt 34 operably coupled to a loaded shaft 36 which could be a portion of an electric rotating device 38 such as a motor generator, etc.

The load applicator and/or threaded shaft 30 may be connected to a strain gauge 40 or other load sensor, such as at connector 42. The strain gauge 40 could be connected a lower connector 44 to a shoulder 46 such as through rod 48 or otherwise. The shoulder 46 may be connected to opposing arms 50,52 which can be respectively connected to base plates 54,56 to which pillow block bearings 58,60 can connect to a test shaft 62 having a pulley 63 thereon. Pillow block bearings 58,60 can be preferably selected to relatively handle the load and speed requirements of the test shaft 62 so as to apply the desired load to the loaded shaft 36 through the belt 34 for testing the bearings such as tested bearing 64 and others of the rotating electrical device 38 and/or any other loaded shaft 36 having tested bearing(s) 64, etc. Other bearings and/or test shafts 62 may be utilized with other embodiments.

The loaded shaft 36 may have a stop 66 so that the belt 34 can contact the loaded shaft directly and/or a pulley along the loaded shaft 36 without coming off inadvertently.

Pillow block bearings 58,60 may be symmetrically disposed and opposing about the test shaft 62 which preferably supports a pulley 63. For some embodiments test device 10 may be provided as a kit to work with a buyer's existing T-plate 12 or other support. Specifically, the load applicator (i.e., for example the threaded rod 30 and nut 32) could be provided as well as the strain gauge 40 and/or other portions.

Leg(s) 68,70 could be a single cross piece or separate pieces provided for stability relative to the posts 16,18. Leg(s) 68,70 could connect with the rod 48 and shoulder 46 along with the arms 50,52 while moving relative to the posts 16,18. The arms 50,52 could be preconnected to the pillow block bearings 58,60 as well as the pulley 63 and the belt 34. This combined structure could be then directed around the loaded shaft 36. The desired amount of tension utilizing the load applicator (in this embodiment the nut 32 and threaded rod 30, although different load applications could be utilized with other embodiments) may then be applied.

The motor or other electrical rotating device 38 could be rotated with the desired load applied by the load applicator as measured by the strain gauge 40 or other load sensor with an output directed to a display 72 which could be a Dyno remote or other display. Display 72 could also be a portion of a controller or processor (or used therewith) in order to automate at least portions of the testing methodology.

In order to change out the belt 34 for at least this embodiment a pillow block bearing 58 or 60 may be disconnected from the base plate 54,56 and then the belt 34 could relatively easily be removed when the load applicator is in an unloaded configuration by removing the test shaft 62 from one or both of the pillow block bearings 58 and/or 60. A new or different belt 34 and/or pulley 63 could be installed for another test after reassembly.

Although most motor repair facilities have a T-plate 12 for those other facilities may not have one. The T-plate 12 could certainly be provided as a portion of the test device 10 for at least some embodiments or the test device 10 could be constructed utilizing a facilities existing T-plate 12.

Due to a relatively simple nature of the test device 10, the test device 10 can be extremely stable and smooth running and virtually allow for an unlimited run time. The tension of belt 34 can be easily adjusted with the rotation of the nut 32 for the illustrated embodiment. Other load applicators may operate differently. Various sizes of the device 10 with various belts 34 can be provided for various embodiments. Strain gauge 40 could be an AW Dyno strain gauge. Other load sensors could be utilized with other embodiments. In the illustrated embodiment, an AW Dyno strain gauge 40 was utilized with a remote 72. However, in other embodiments, other displays 72 and/or controllers could be utilized as could other load sensors such as strain gauge 40 and others. Any shop scale could be relatively easily fitted to assist in measuring tension. Various belts 34 of configurations and/or lengths or sizes could be utilized based on the size of the electrical rotating device 38 aka motor and or other load requirements for the loaded shaft 36. Pulley 63 could be o various construction based on the design of the belt 34. A two groove belt 34 and pulley 63 could be utilized as illustrated or other appropriate belts 34 and pulley 63 could be utilized. Guards could be provided for various embodiments to protect the users from the belt 34 and/or other moving parts.

One of ordinary skill in the art would quickly see that the device 10 is particularly flexible and adaptable to be able to apply a load or a plurality of loads to virtually any loaded shaft 36 (rotating at one or more speeds and/or otherwise) to test bearings such as tested bearing(s) 64 and/or others under various conditions such as operating conditions and/or other desired test conditions in a safe and effective manner. Loads could be varied during a test for various embodiments as well, possibly in an automated manner with controller, if utilized.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the intention are intended to be included within the scope of the appended claims.

Having thus set forth the nature of the invention, what is claimed herein is:

1. A test device comprising:
a crossbar;
a load applicator adjustably connected to the crossbar,
a sensor connected to the load applicator measuring one of compression and tension applied to the load applicator;
a pulley connected to the load applicator; and
a belt, said belt directed about the pulley and a test article selected from the group of a rotating shaft and a bearing; wherein the load applicator applies a load to the test article with the sensor providing sensor output related to the load while rotating the test article.

2. The test device of claim 1 wherein the load applicator further comprises a shaft linearly displaceable relative to the crossbar.

3. The test device of claim 2 wherein the shaft has threads and rotation of a nut linearly displaces the shaft relative to the crossbar.

4. The test device of claim 1 further comprising a processor connected to the output of the sensor.

5. The test device of claim 4 further comprising a display displaying the load.

6. The test device of claim 1 further comprising opposing posts supporting the crossbar, said posts connected at a lower portion to a base.

7. The test device of claim 6 wherein the base is connected to tracks.

8. The test device of claim 2 further comprising a shoulder intermediate the shaft and the pulley.

9. The test device of claim 8 further comprising opposing arms extending from the shoulder supporting the pulley therebetween.

10. The test device of claim 9 further comprising bearings connected to each of the arms, and the pulley connects to a test shaft between the bearings.

11. The test device of claim 10 further comprising a rod connecting the shoulder to the sensor.

12. The test device of claim 6 further comprising a shoulder intermediate the shaft and the pulley and legs extending relative to the shoulder, said legs guiding the shoulder relative to the posts.

13. The test device of claim 12 wherein the load applicator further comprises a shaft linearly displaceable relative to the crossbar and the legs assist in linear movement relative to the posts.

14. The test device of claim 4 wherein the processor assists in automatedly applying a predetermined load as the load.

15. The test device of claim 14 wherein the load is applied by the processor for a predetermined time.

16. The test device of claim 1 wherein the sensor is a strain gage.

17. The test device of claim 1 further comprising a stop located on the test article assisting in retaining the belt on the test article.

18. The test device of claim 1 wherein the load applicator is oriented perpendicularly to a direction of rotation of the pulley.

19. The test device of claim 1 wherein the load applicator applies a vertically directed force through the pulley to the test article.
